(19) United States
(12) Patent Application Publication
(10) Pub. No.: US 2024/0051185 A1
(43) Pub. Date: Feb. 15, 2024

(54) RECYCLING METHOD FOR CONTAMINATED POLYOLEFINS

(71) Applicant: ALPLA WERKE ALWIN LEHNER GMBH & CO. KG, Hard (AT)

(72) Inventor: Robert Siegl, Dornbirn (AT)

(21) Appl. No.: 18/258,198

(22) PCT Filed: Dec. 16, 2021
(86) PCT No.: PCT/EP2021/086141

§ 371 Date: Jun. 16, 2023

(30) Foreign Application Priority Data
Dec. 16, 2020 (CH) 01595/20

(51) Int. Cl. B29B 17/02

(52) U.S. Cl. CPC B29B 17/02; B29B 2017/0289

(57) ABSTRACT

The invention relates to a recycling method for producing a polyolefin recyclate, involving the process of removing contaminants from a contaminated polyolefin material, in which the contaminated polyolefin material is soaked in a solvent in a soaking step in order to dissolve contaminants present in the contaminated polyolefin material in the solvent and to remove the solvent and the contaminants dissolved in the solvent from the polyolefin material. According to the invention, prior to the soaking step, a washing step carried out using water, cleaning agents and/or lye. The contaminated polyolefin material is changed by the soaking/solvent recycling method such that (i) more than 90% of the low-molecular chains of below 2000 daltons are removed or washed out, and the average molecular chain length of the polyolefin recyclate is therefore increased, and (ii) the melt volume-flow rate (MVR) of the polyolefin recyclate is reduced to a specified MVR.

### CROSS-REFERENCE TO RELATED APPLICATIONS

This application is a national phase entry under 37 U.S.C § 371 of PCT/EP2021/086141 filed Dec. 16, 2021, which claims priority to Swiss Patent Application No. 01595/20 filed Dec. 16, 2020, the entirety of each of which is incorporated by this reference.

### FIELD OF THE INVENTION

The invention relates to a recycling method for producing a polyolefin recyclate and a polyolefin recyclate produced by the recycling method.

### PRIOR ART

HDPE (high-density polyethylene) material continues to degrade further during the processing process and later over the course of time depending on stabilization and loading, i.e., the molecular weight of the HDPE continues to fall. This degradation in molecular weight is not compensated again by conventional mechanical recycling methods. Although compensation methods are known from the literature, they are not of economic interest due to the high technical complexity involved, such as the application of high pressures or the introduction of special catalysts.

HDPE stabilizers or antioxidants such as Irganox 1010 or Irgafos 168, which are admixed into the starting material at between 500 and 3000 mg/kg, lose their effect due to their reaction mechanisms, for example, with oxygen and radicals. After each instance of thermal loading and thus each subsequent use in the cycle, stabilizers and antioxidants must be supplemented in order to achieve the properties of the starting material. However, stabilizers and decomposition products such as 3,5-di-tert-butyl-4-hydroxybenzaldehyde from Irganox 1010 are not removed or only insufficiently removed by the known recycling methods and remain in the recycled material. However, this accumulation of stabilizers and their decomposition products is problematic in the use of food packaging, since they can contaminate the food or can adversely affect the taste of the food.

HDPE material is represented on the market in a wide variety of colors, wherein the pigments cannot be removed by the usual mechanical recycling methods. Accordingly, a separate recycling stream must be created for each color. However, this approach fails since a minimum amount of HDPE material of a single color is not achieved and recycling is thus uneconomic.

Over time, HDPE material absorbs by migration contaminants, such as, for example, nonenal and/or nonanal, which usually have a negative effect on odor. Decomposition products which negatively influence the odor are also formed in the HDPE itself. Decomposition products can be, for example, butyric acid or valeric acid. Butyric acid can arise from the container to be recycled having been filled with a dairy product or even from carnauba wax, which is frequently used as a mold release agent and decomposes to butyric acid under solar irradiation. As already explained, decomposition products that have migrated into the material to be recycled are not removed or only insufficiently removed by common recycling methods. For this reason, material from the usual mechanical HDPE recycling methods is often accompanied by an unpleasant smell.

HDPE materials release their contaminants only slowly, so that most and conventional mechanical recycling methods cannot provide a recyclate that permits direct contact with food. For example, fuels and oils are stored in containers made of polyolefins, made of HDPE. As a result, concentrations of benzene and other MOAHs (mineral oil aromatic hydrocarbons) of 5000 to 10 000 mg/kg of polyolefin are reached in the container walls. For contact with foods, such contaminants must be removed in a sufficient quantity by the method in order to make it possible to use the regenerated HDPE as food packaging.

HDPE materials contain very low molecular chains (oligomers, POSHs (polyolefin oligomeric saturated hydrocarbons), POAHs) of below 2000 daltons, which are perceived as a waxy or oily unpleasant-smelling aroma or which contaminate food. Mechanical recycling methods cannot remove these low-molecular chains sufficiently, but they do degrade the material to be recycled further and thus increase the number of low-molecular chains from recycling cycle to recycling cycle.

### Advantages of the Invention

An advantage of the invention can thus be to provide a cost-effective method for producing recycled HDPE material which can be used as food packaging.

### DETAILED DESCRIPTION OF THE INVENTION

In the case of a recycling method for the production of a polyolefin recyclate, the stated advantage of the invention is achieved by the features in the subject matter of the independent claims. Developments and/or advantageous alternative embodiments form the subject matter of the dependent claims.

A recycling method for producing a polyolefin recyclate is proposed. The recycling method comprises the removal of contaminants from a contaminated polyolefin material, in which the contaminated polyolefin material is soaked in a solvent in a soaking step in order to dissolve in the solvent contaminants present in the contaminated polyolefin material and to remove the solvent and the contaminants dissolved in the solvent from the contaminated polyolefin material. Before the soaking step, a washing step is carried out with water, cleaning agents and/or lye and the contaminated polyolefin material is changed by the soaking/solvent recycling method such that (i) more than 90 percent by weight of the low-molecular contaminants of below 2000 daltons are removed or washed out, and the average molecular chain length of the polyolefin is thereby increased, and (ii) the melt volume-flow rate (MVR) of the polyolefin recyclate, which has risen due to decomposition and aging, is reduced to a specified MVR. Surprisingly, the contaminants contained in the contaminated polyolefin material that is to be regenerated or recycled can be removed particularly easily from the contaminated polyolefin material. Purification efficiency refers to the concentration of contaminants prior to the washing method compared to the concentration after the soaking method, more particularly after removal of the solvent and the contaminants dissolved in the solvent. Depending on the proportion of low-molecular contaminants, 0.5 g to 5 g per kg of contaminated polyolefin material can be separated off by the proposed method. The specified MVR for the production of different products is not necessarily always the same. The MVR of the polyolefin recyclate is can, for example, be reduced to the MVR of the polyolefin material before initial processing, that is to say, to the MVR which the virgin polyolefin (hereinafter referred to as “virgin material”) has before it is melted for the first time in the extruder. Depending on the intended use of the regenerated or recycled polyolefin material, the desired MVR may be different. In fact, the MVR can also be set such that films, threads, rods, sheets, pipes, injection-molded parts or hollow blow-molded bodies can be produced from the recycled polyolefin material. Ideally, the MVR of the polyolefin recyclate is equal to the MVR of the polyolefin material before initial processing. The degree and speed of removal of the low-molecular contaminants of below 2000 daltons can be influenced by the residence time of the contaminated polyolefin material in the solvent, the temperature of the solvent and by application of pressure. For instance, the low-molecular contaminants of below 2000 daltons can be soaked within 25 minutes to 100% at a solvent temperature of 150° C. and at 12 bar pressure. A regenerated or recycled polyolefin material is also known under the name “post-consumer recyclate (PCR).”

The difference from the commercially available regenerated polyolefin materials lies in the molecular weight distribution: The mechanical methods currently available on the market cannot reduce the low-molecular contaminants of below 2000 daltons in the contaminated polyolefin material. In fact, from recycling cycle to recycling cycle, the low-molecular contaminants of below 2000 daltons accumulate in the recycled polyolefin material. The accumulation of the recycled polyolefin material with the low-molecular contaminants of below 2000 daltons increases the MVR. With the proposed method, by contrast, the average molecular weight of the polyolefin material can be increased by the removal of the low-molecular contaminants of below 2000 daltons and the MVR is reduced accordingly.

In another embodiment, more than 90% of stabilizers and antioxidants and their reaction products of below 2000 daltons are removed from the contaminated polyolefin material and new stabilizers and antioxidants are introduced into the polyolefin recyclate. Antioxidants or anti-aging agents are known, for example, under the trade names of Irganox 1010 or Irgafos 168. The difference from the polyolefin recyclates currently available on the market produced by a conventional mechanical recycling method therefore consists in the removal of the stabilizers (antioxidants) from the polyolefin material to be recycled. For example, Irganox 1010 has 292 daltons and is added to the virgin material at between 500 mg and 3000 mg per kg of virgin material. A typical reaction product of Irganox 1010 is 3,5-di-tert-butyl-4-hydroxybenzaldehyde. By means of the proposed method, the proportion of 3,5-di-tert-butyl-4-hydroxybenzaldehyde can be reduced to less than 50 mg per kg of polyolefin recyclate. According to its use, new and fresh stabilizers of about 450 mg to about 2950 mg per kg of polyolefin recyclate can then be added to the polyolefin recyclate. The polyolefin recyclate thus has at least substantially the same properties as the virgin material.

According to a further exemplary embodiment, encapsulated dyes present in the contaminated polyolefin material lose the protective effect of the capsule by the capsule being dissolved and/or opened up by the solvent and more than 90% of the color-active molecules of below 2000 daltons being washed out of the contaminated polyolefin material by the method. Typically, 1 percent by weight of color masterbatch per kg of polyolefin material is added to the polyolefin material to be dyed. In the present example, the color masterbatch contains 20 percent by weight of Solvent Red 111 (C15H11NO2 CAS 82-38-2) with a molecular weight of 237 daltons. By means of the proposed recycling method, at least 1800 mg of Solvent Red 111 per kg of polyolefin material can be removed from the 2000 mg of Solvent Red 111 per kg of polyolefin material originally present. By means of the proposed recycling method, in addition to Solvent Red 111, among other things the following dyes can be washed out of the contaminated polyolefin material that is to be regenerated: Solvent Yellow 93, 114, Solvent Red 242, 179, 195, Solvent Green 3, 5, 28, Solvent Blue 101, 36, 97, 35, 104 and calcium carbonate for opaque shades. Capsules of polystyrene, polyamide, polyester and SIOx can be made to break open or dissolve by solvents, for example acetone, alkalis or alcohols, but also by heat, pressure or radiation. The polyolefin recyclate obtained according to the proposed recycling method can be redyed. The known mechanical recycling processes do not or only insufficiently remove the above-mentioned dyes.

In another embodiment, more than 99% of residues of mineral oils such as MOAHs (mineral oil aromatic hydrocarbons) and MOSHs (mineral oil saturated hydrocarbons), together with the POAHs (polyolefin aromatic hydrocarbons) and POSHs (polyolefin saturated hydrocarbons) having a molecular weight of less than 500 daltons and naturally occurring in the polyolefin, are washed out or removed from the contaminated polyolefin material. Mechanically purified polyolefin recyclates on the market have undesirable hydrocarbon contaminants which occur due to the processing of the packaging material (printing ink, mineral oils of processing machines, etc.) or which already occur naturally in the virgin material.

In a further embodiment, more than 90% of model contaminants toluene, chlorobenzene, phenylcyclohexane, benzophenone and methyl stearate are removed from the contaminated polyolefin material. Model contamination is understood to mean the accumulation of said contaminants in the polyolefin material to be regenerated in concentrations of 500 mg to 1500 mg per kg of polyolefin material to be regenerated. In order to pass the prescribed test of the European Food Safety Authority (EFSA) for approval as a food-safe plastic, it is mandatory that at least 90% of each model contaminant is removed by the recycling method. Tests have shown that with the proposed recycling method a contamination, for example, with chlorobenzene and/or toluene of 1000 mg per kg of polyolefin material to be recycled an accumulation of up to 5 mg per kg of polyolefin recyclate could be removed and thus 99.5 percent by weight. In contrast, mechanically purified recycled HDPE material from the prior art will not as a rule pass the test of the EFSA (European Food Safety Authority) which is carried out for the safe use of the material in the case of food contact. The polyolefin recyclate from mechanical recycling methods according to the prior art can pass the EFSA test only in the case of low contamination and unmixed streams of polyolefin material to be regenerated, as is the case, for example, with HDPE packaging for milk in the UK.

Advantageously, more than 90% of plasticizers which are partly used in soft PVC, in particular orthophthalates, in particular DEHP, are removed from polyolefin material contaminated by PVC. Polyolefin material absorbs these plasticizers very well and for this reason these plasticizers, although primarily not a component of virgin material, are also disadvantageously present in known mechanically purified polyolefin recyclate.

According to a further exemplary embodiment, a concentration of DEHP in the polyolefin recyclate is less than 0.1 mg per kg of polyolefin recyclate.

According to a further exemplary embodiment, more than 90% of odor-active carbon compounds of below 500 daltons, for example carboxylic acids, in particular butyric acid and valeric acid, odor-active saturated and unsaturated aldehydes, in particular nonanal and nonenal, odor-active lactones such as, for example, nonalactone and/or ε-caprolactone, and also odor-active terpenes such as, for example, limonene and/or p-cymene, are removed from the contaminated polyolefin material.

Limonene is one of the main components in the olfactory perception of citrus fruits and one of the most important components in lemonades. In the case of polyolefins, lemonades play a subordinate role, but cleaning agent with a citrus or orange scent based on limonene is admixed to the cleaning agent at above 1000 mg of limonene per liter. A typical limonene contamination in the polyolefin material can thereby be, for example, 600 ppm and reduced by the method to below 6 ppm.

In contrast to this, standardly mechanically recycled polyolefin material, pellets produced therefrom and containers produced therefrom often have a very unpleasant odor which affects the taste of the foods stored in these containers.

It has been found that the proposed recycling method reduces nonenal, nonanal and nonalactone in the polyolefin recyclate, in particular in an HDPE recyclate, in each case to less than 0.1 mg per kg of polyolefin recyclate, in particular HDPE recyclate.

It proves advantageous if the solvent is n-hexane or n-heptane or a mixture thereof. These solvents have been found to be particularly efficient with a great broad-spectrum effect for removing low-molecular contaminants of below 2000 daltons, in particular the contaminants described above. In addition, this solvent can be separated from the polyolefin recyclate virtually without residue.

Advantageously, the contaminated polyolefin material is soaked in the solvent at a temperature of approximately 10° K below the melting temperature of the polyolefin material to be regenerated and at a pressure between 1 and 1000 bar, as a result of which 99.9% of biofilms and germs present in the polyolefin material to be regenerated are killed. As a result, not only the average molecular chain length of the regenerated material can be increased and contaminants removed, but a polyolefin recyclate suitable for filling with foods can also be produced.

Another aspect of the invention relates to a purified polyolefin material, or polyolefin recyclate, produced by the recycling method described above, wherein the polyolefin recyclate is present in the form of pellets. This regenerated polyolefin material has almost the properties of virgin material and is therefore far superior in its quality to recycled materials in a mechanical.

The polyolefin recyclate advantageously contains less than 50 mg of 3,5-di-tert-butyl-4-hydroxybenzaldehyde per kg of polyolefin recyclate.

It is understood that developments and advantageous embodiments which are described on the basis of the recycling method also apply where appropriate to the polyolefin recyclate produced by means of the recycling method, and vice versa.

1. A recycling method for producing a polyolefin recyclate, comprising:
washing a contaminated polyolefin material in water, cleaning agents and/or lye; and
removing contaminants from a contaminated polyolefin material by soaking the contaminated polyolefin material in a solvent in order to dissolve contaminants present in the contaminated polyolefin material in the solvent and to remove the solvent and the contaminants dissolved in the solvent from the contaminated polyolefin material;
whereby the soaking in the solvent changes the contaminated polyolefin material such that (i) 90 percent by weight of the low-molecular contaminants of below 2000 daltons and decomposition products of the polyolefin are removed or washed out, and an average molecular chain length of the polyolefin recyclate is thereby increased and (ii) a melt volume-flow rate (MVR) of the polyolefin recyclate is reduced to a specified MVR.

2. The recycling method according to claim 1, further comprising removing more than 90% of stabilizers and antioxidants and the reaction products thereof of below 2000 daltons from the contaminated polyolefin material and introducing new stabilizers and antioxidants into the polyolefin recyclate.

3. The recycling method according to claim 1, wherein encapsulated dyes present in the contaminated polyolefin material lose the protective effect of a capsule by the capsule being dissolved and/or opened up by the solvent and by more than 90% of a color-active molecules of below 2000 daltons being washed out.

4. The recycling method according to claim 1, wherein more than 90% of residues of mineral oils including MOAHs (mineral oil aromatic hydrocarbons) or MOSHs (mineral oil saturated hydrocarbons), together with POAHs (polyolefin aromatic hydrocarbons) and POSHs (polyolefin saturated hydrocarbons) having a molecular weight of below 500 daltons and naturally occurring in the polyolefin material, are washed out or removed from the contaminated polyolefin material.

5. The recycling method according to claim 1, wherein more than 90% of each model contaminant from a group comprising toluene, chlorobenzene, phenylcyclohexane, benzophenone or methyl stearate is removed from the contaminated polyolefin material.

6. The recycling method according to claim 1, wherein more than 90% of plasticizers at least partly used in soft PVC are removed from the contaminated polyolefin material.

7. The recycling method according to claim 6, wherein a concentration of DEHP in the polyolefin recyclate is less than 0.1 mg per kg of the polyolefin recyclate.

8. The recycling method according to claim 1, wherein more than 90% of odor-active carbon compounds of below 500 daltons, the odor-active compounds comprising at least one of carboxylic acids, butyric acid, and valeric acid, odor-active saturated or unsaturated aldehydes, nonanal or nonenal, odor-active lactones, nonalactone, odor-active, or limonene are removed from the contaminated polyolefin material.

9. The recycling method according to claim 1, wherein nonenal, nonanal and nonalactone in the polyolefin recyclate, are each reduced to less than 0.1 mg per kg of polyolefin recyclate.

10. The recycling method according to claim 1, wherein the solvent is n-hexane or n-heptane or a mixture thereof.

11. The recycling method according to claim 1, wherein the contaminated polyolefin material is soaked in the solvent at a temperature of approximately 10° K below the melting temperature of the polyolefin material to be regenerated and at a pressure between 1 and 1000 bar, a result of which 99.9% of biofilms and germs present in the polyolefin material to be regenerated are killed.

12. A polyolefin recyclate produced by a method comprising:
washing a contaminated polyolefin material in water, cleaning agents and/or lye; and
removing contaminants from a contaminated polyolefin material by soaking the contaminated polyolefin material in a solvent in order to dissolve contaminants present in the contaminated polyolefin material in the solvent and to remove the solvent and the contaminants dissolved in the solvent from the contaminated polyolefin material;
whereby the soaking in the solvent changes the contaminated polyolefin material such that (i) 90 percent by weight of the low-molecular contaminants of below 2000 daltons and decomposition products of the polyolefin are removed or washed out, and an average molecular chain length of the polyolefin recyclate is thereby increased and (ii) a melt volume-flow rate (MVR) of the polyolefin recyclate is reduced to a specified MVR.
wherein the polyolefin recyclate is in the form of pellets.

13. The polyolefin recyclate according to claim 12, wherein the polyolefin recyclate contains less than 50 mg of 3,5-di-tert-butyl-4-hydroxybenzaldehyde per kg of the polyolefin recyclate.

14. The polyolefin recyclate according to claim 12, wherein encapsulated dyes present in the contaminated polyolefin material lose the protective effect of a capsule by the capsule being dissolved and/or opened up by the solvent and by more than 90% of a color-active molecules of below 2000 daltons being washed out.

15. The polyolefin recyclate according to claim 12, wherein encapsulated dyes present in the contaminated polyolefin material lose the protective effect of a capsule by the capsule being dissolved and/or opened up by the solvent and by more than 90% of a color-active molecules of below 2000 daltons being washed out.

16. The polyolefin recyclate according to claim 12, wherein more than 90% of residues of mineral oils including MOAHs (mineral oil aromatic hydrocarbons) or MOSHs (mineral oil saturated hydrocarbons), together with POAHs (polyolefin aromatic hydrocarbons) and POSHs (polyolefin saturated hydrocarbons) having a molecular weight of below 500 daltons and naturally occurring in the polyolefin material, are washed out or removed from the contaminated polyolefin material.

17. The polyolefin recyclate according to claim 12, wherein more than 90% of each model contaminant from a group comprising toluene, chlorobenzene, phenylcyclohexane, benzophenone or methyl stearate is removed from the contaminated polyolefin material.

18. The polyolefin recyclate according to claim 12, wherein more than 90% of plasticizers at least partly used in soft PVC are removed from the contaminated polyolefin material.

19. The polyolefin recyclate according to claim 18, wherein a concentration of DEHP in the polyolefin recyclate is less than 0.1 mg per kg of the polyolefin recyclate.

20. The polyolefin recyclate according to claim 12, wherein more than 90% of odor-active carbon compounds of below 500 daltons, the odor-active compounds comprising at least one of carboxylic acids, butyric acid, and valeric acid, odor-active saturated or unsaturated aldehydes, nonanal or nonenal, odor-active lactones, nonalactone, odor-active, or limonene are removed from the contaminated polyolefin material.
